(19) United States
(12) Patent Application Publication
(10) Pub. No.: US 2015/0189331 A1
(43) Pub. Date: Jul. 2, 2015

(54) IMAGE DATA COMMUNICATION METHOD AND IMAGE DATA COMMUNICATION DEVICE

(71) Applicant: Electronics and Telecommunications Research Institute, Daejeon (KR)

(72) Inventors: Ki Jong KOO, Daejeon (KR); Do Young KIM, Daejeon (KR)

(21) Appl. No.: 14/577,537

(22) Filed: Dec. 19, 2014

(30) Foreign Application Priority Data
Dec. 27, 2013 (KR) 10-2013-0165362
Apr. 29, 2014 (KR) 10-2014-0051262

(51) Int. Cl. H04N 19/89; H04N 7/15; H04L 29/06

(52) U.S. Cl. CPC H04N 19/89; H04L 65/608; H04N 7/15

(57) ABSTRACT

Provided is an image data communication method. The method comprises generating encoding data by encoding image data, generating recovery data by using the encoding data, generating packets by packetizing the encoding data and the recovery data, and transmitting the generated packets. The generating of the recovery data comprises dividing the encoding data into a plurality of fragmented data, and generating the recovery data by performing an XOR operation on at least two fragmented data among the plurality of fragmented data.

### CROSS-REFERENCE TO RELATED APPLICATIONS

This U.S. non-provisional patent application claims priority under 35 U.S.C. §119 of Korean Patent Application Nos. 10-2013-0165362, filed on Dec. 27, 2013, and 10-2014-0051262, filed on Apr. 29, 2013, the entire contents of which are hereby incorporated by reference.

### BACKGROUND OF THE INVENTION

The present invention disclosed herein relates to a communication device, and more particularly, to an image data communication method and an image data communication device.

With the developments of image processing techniques and data communication techniques, techniques of requiring real-time image data communication, for example, video conferencing, are studied. One of the main factors that determine the quality of a video conferencing system is packet loss. Once packet is missing, an image corresponding to the missing packet is damaged, so that the quality of an image played through an image conferencing system is deteriorated.

As one example of an existing video conferencing system, there is a video conferencing system using dedicated network. The dedicated network is managed easily and there is less interference by other users or environments. Accordingly, in a video conferencing system using dedicated network, packet loss may be managed lower than a threshold that is appropriate for video conferencing. However, the construction costs of the image conferencing system using the dedicated network are high.

As one attempt for establishing a video conferencing system using public network, a video conferencing system using steaming technique is suggested. Once steaming technique is applied, image data is buffered and then played. During buffering, the re-transmission of missing packets may be performed and accordingly, the quality of a played image may be improved. However, in a real-time image conferencing system, a buffering time may cause the delay of image playback and may deteriorate the quality of an image conferencing system.

The image conferencing system may be applied to a wireless environment. The wireless environment experiences more noises than a wired environment. Therefore, a packet loss rate of the wireless environment is higher than that of the wired environment.

Therefore, image data communication techniques for implementing a real-time image data communication in an environment where a packet loss rate is high like public network and wireless environment are required.

### SUMMARY OF THE INVENTION

The present invention provides an image data communication method and an image data communication device with improved reliability and speed.

Embodiments of the present invention provide image data communication methods including: generating encoding data by encoding image data; generating recovery data by using the encoding data; generating packets by packetizing the encoding data and the recovery data; and transmitting the generated packets; wherein the generating of the recovery data includes: dividing the encoding data into a plurality of fragmented data; and generating the recovery data by performing an XOR operation on at least two fragmented data among the plurality of fragmented data.

In some embodiments, the generating of the recovery data may include performing an XOR operation on odd fragmented data among the plurality of fragmented data.

In other embodiments, the generating of the recovery data may include performing an XOR operation on even fragmented data among the plurality of fragmented data.

In still other embodiments, the plurality of fragmented data may be divided into a plurality of groups and the generating of the recovery data may include performing an XOR operation on fragmented data in a group selected from the plurality of groups.

In even other embodiments, the generating of the recovery data may further include performing an XOR operation on at least two second fragmented data among the plurality of fragmented data to generate second recovery data, and wherein during the generating of the packets, the second recovery data may be packetized together with the encoding data and the recovery data.

In yet other embodiments, the at least two second fragmented data may not overlap with the at least two fragmented data.

In further embodiments, the at least two second fragmented data may include fragmented data overlapping at least one fragmented data among the at least two fragmented data.

In still further embodiments, during the generating of the packets, the second recovery data and the recovery data may be packetized into different packets.

In even further embodiments, the generating of the packets may include: packetizing the plurality of fragmented data into a plurality of first packets, respectively; and packetizing the recovery data into a second packet.

In yet further embodiments, the second packet may include a real-time transport protocol (RTP) header and an RTP payload including the recovery data; and the RTP header includes information on a type of the RTP payload, a sequence number indicating an order of the RTP payload, and a timestamp indicating a time at which the RTP payload is sampled.

In yet further embodiments, the RTP payload may include a packet loss recovery (PLR) header and a PLR payload including the recovery data; and the PLR header may include information on a PLR indicator indicating the at least two fragmented data, a packet number indicating a number of the plurality of fragmented data, and a size of a last fragmented data among the plurality of fragmented data.

In yet further embodiments, when the recovery data is packetized into at least two packets, the PLR header may further include information on a number of the at least two packets.

In yet further embodiments, each of the first packets may include an RTP header and an RTP payload including corresponding fragmented data among the plurality of fragmented data; and the RTP header may include information on a type of the RTP payload, a sequence number indicating an order of the RTP payload, and a timestamp indicating a time at which the RTP payload is sampled.

In yet further embodiments, the RTP payload may include a fragmentation unit (FU) indicator, an FU header, and an FU payload including the corresponding fragmented data; the FU indicator may include information on a fixed bit indicating whether there is an error, a reference indicator indicating whether image data corresponding to the FU payload is used as a reference, and a type of the FU payload; and the FU header may include a start bit indicating a start of the plurality of fragmented data, an end bit indicating an end of the plurality of fragmented data, and a type of the FU payload.

In other embodiments of the present invention, image data communication methods include: receiving a plurality of packets and at least one recovery packet; determining whether a missing packet exists among the plurality of packets; performing a missing packet recovery by using the plurality of packets and the at least one recovery packet when the missing packet exists, so as to recovery the image data; and performing decoding on the plurality of packets when the missing packet does not exist, so as to recover the image data, wherein the missing packet recovery is performed by using an XOR operation on at least one packet among the plurality of packets and the recovery packet.

In some embodiments, the missing packet recovery may include: detecting first packets relating to the at least one recovery packet from the at least one recovery packet; determining whether the missing packet is a recovery target on the basis of the missing packet and the first packets; when the missing packet is the recovery target, recovering the missing packet on the basis of the at least one recovery packet and the first packets; and when the missing packet is not the recovery target, terminating the missing packet recovery.

In other embodiments, the determining of whether the missing packet is the recovery target may include, when the missing packet is one of the first packets, determining the missing packet as the recovery target.

In still other embodiments, the recovering of the missing packet may include performing an XOR operation on the remaining packets except for the missing packet among the first packets and the recovery packet, so as to recover the missing packet.

In even other embodiments, the missing packet may include first and second missing packets, wherein the missing packet recovery may include: detecting first packets relating to a first recovery packet among the at least one recovery packet; detecting second packets relating to a second recovery packet among the at least one recovery packet; selecting a first priority recovery packet from the first recovery packet and the second recovery packet on the basis of the first and second missing packets, the first packets, and the second packets; recovering one missing packet among the first and second missing packets by using the first priority recovery packet and packets relating to the first priority recovery packet; and recovering the remaining one missing packet among the first and second missing packets by using a second priority recovery packet among the first recovery packet and the second recovery packet and packets relating to the second priority recovery packet.

In still other embodiments of the present invention, image data communication devices include: a first encoding and decoding unit encoding an image signal to output the encoded signal as a first down signal, receiving a first up signal, and decoding the first up signal to recovery the image signal; a second encoding and decoding unit receiving the first down signal, performing missing packet recovery encoding on the first down signal to output the encoded signal as a second down signal, receiving a second up signal, and performing missing packet recovery decoding on the second up signal to output the decoded signal as the first up signal; a packetizing and depacketizing unit receiving the second down signal, packetizing the second down signal to output the packetized signal as a third down signal, receiving a third up signal, and depacketizing the third up signal to output the depacketized signal as the second up signal; and a transceiver receiving the third down signal to transmit the received signal to an external device and receiving the third up signal from the external device to output the received signal, wherein the missing packet recovery encoding further includes dividing the first down signal into a plurality of first fragmented data, performing an XOR operation on at least two fragmented data among the plurality of first fragmented data to generate first recovery data, and outputting the plurality of first fragmented data and the first recovery data as the second down signal; and the missing packet recovery decoding includes recovering missing data by using a plurality of second fragmented data and second recovery data of the second up signal and outputting the plurality of second fragmented data and the recovered data as the first up signal.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a conceptual diagram illustrating a vide conferencing system according to an embodiment of the present invention;

FIG. 2 is a block diagram illustrating an image data communication device according to an embodiment of the present invention;

FIG. 3 is a flowchart illustrating a method of an image data communication device to transmit image data according to an embodiment of the present invention;

FIG. 4 is a flowchart illustrating a method of an image data communication device to encode image data according to an embodiment of the present invention;

FIG. 5 is a view illustrating an NAL unit generated by an image data communication device;

FIG. 6 is a flowchart illustrating a method of an image data communication device to perform missing packet recovery decoding and packetizing on data and transmit it according to an embodiment of the present invention;

FIG. 7 is a view when each fragmented data of an RBSP in an NAL unit is packetized;

FIG. 8 is a view illustrating an RTP payload including fragmented data;

FIG. 9 is a flowchart when an image data communication device performs an operation on selected fragmented data with odd data or even data;

FIG. 10 is a view of generating recovery data;

FIG. 11 is a view illustrating an RTP payload including recovery data;

FIG. 12 is a flowchart when an image data communication device receives and processes RTP packets according to an embodiment of the present invention;

FIG. 13 is a flowchart illustrating a method of an image data communication device to determine whether there is a missing packet according to an embodiment of the present invention;

FIG. 14 is a flowchart illustrating a method of an image data communication device to determine whether there is a missing packet according to another embodiment of the present invention;

FIG. 15 is a flowchart illustrating a method of an image data communication device to perform a missing packet recovery operation according to an embodiment of the present invention;

FIG. 16 is a view when a missing packet recovery is performed according to an embodiment of the present invention; and

FIG. 17 is a view when a missing packet recovery is performed according to another embodiment of the present invention.

### DETAILED DESCRIPTION OF PREFERRED EMBODIMENTS

Hereinafter, preferred embodiments of the present invention will be described with reference to the accompanying drawings to fully explain the present invention in such a manner that it may easily be carried out by a person with ordinary skill in the art to which the present invention pertains.

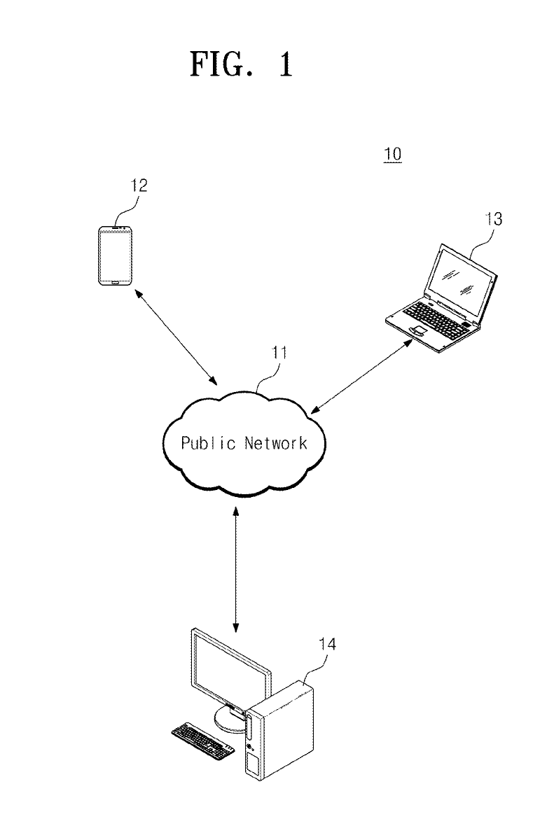

FIG. 1 is a conceptual diagram illustrating a video conferencing system 10 according to an embodiment of the present invention. Referring to FIG. 1, the video conferencing system 10 includes a public network 11 and image data communication devices 12, 13, and 14.

The public network 11 may be a network accessed by a plurality of communication devices. The public network 11 may include internet and wireless communication channels.

The image data communication devices 12, 13, and 14 may capture images and voices to generate image data and voice data. The image data communication devices 12, 13, and 14 may transmit the generated image and voice data to the public network 11. The image data communication devices 12, 13, and 14 may receive image and voice data from the public network 11. The image data communication devices 12, 13, and 14 may play images and voices by using the received image data and voice data. The image data communication devices 12, 13, and 14 may be devices supporting real-time video conferencing.

Hereinafter, for concise description, it is described that the image data communication devices 12, 13, and 14 process images and image data. However, the image data communication devices 12, 13, and 14 may process voices and voice data in addition to images and image data.

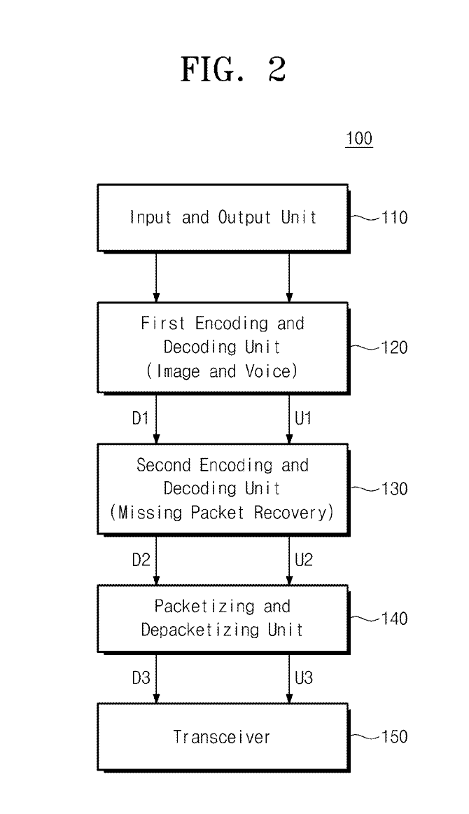

FIG. 2 is a block diagram illustrating an image data communication device 100 according to an embodiment of the present invention. Referring to FIG. 2, the image data communication device 100 includes an input and output unit 110, a first encoding and decoding unit 120, a second encoding and decoding unit 130, a packetizing and depacketizing unit 140, and a transceiver 150.

The image data communication device 100 includes a downlink D processing image data and transmitting it to an external device and an uplink U recovering image data by using signals transmitted from an external device. Hereinafter, after description relating to a downlink D of the image data communication device 100 is provided, description relating to an uplink U of the image data communication device 100 is provided.

The input and output unit 110 may receive signals from a user or output signals to a user. The input and output unit 110 may include a user input means such as a camera capturing images and a mike capturing voices. The input and output unit 110 may capture images to generate image data and also may output the generated image data to the first encoding and decoding unit 120.

The first encoding and decoding unit 120 performs encoding and decoding on the image data. The first encoding and decoding unit 120 may receive the image data from the input and output unit 110 and may then encode the received image data. For example, the first encoding and decoding unit 120 may encode image data on the basis of the standards such as II.264/AVC and HEVC. The first encoding and decoding unit 120 may output the encoded data as a first down signal D1 to the second encoding and decoding unit 130.

The second encoding and decoding unit 130 receives the first down signal D1 from the first encoding and decoding unit 120. The second encoding and decoding unit 130 may perform packet loss recovery decoding on the first down signal D1. Once the packet loss recovery decoding is performed, recovery data relating to the first down signal D1 is generated. The second encoding and decoding unit 130 may transmit the first down signal D1 and recovery data as a second down signal D2 to the packetizing and depacketizing unit 140.

The packetizing and depacketizing unit 140 receives the second down signal D2 from the second encoding and decoding unit 130. The packetizing and depacketizing unit 140 may packetize the second down signal D2 to generate packets. The packetizing and depacketizing unit 140 may transmit the generated packets as a third down signal D3 to the transceiver 150.

The transceiver 150 receives the third down signal D3 from the packetizing and depacketizing unit 140. The transceiver 150 transmits/receives the second down signal D3 to/from the public network 11 (see FIG. 1).

The transceiver 150 may receive signals from the public network 11. The transceiver 150 may transmit the signals received from the public network 11 to the packetizing and depacketizing unit 140 as a third up signal U3.

The packetizing and depacketizing unit 140 receives the third up signal U3 from the transceiver 150. The packetizing and depacketizing unit 140 may perform depacketizing on the third up signal U3. The packetizing and depacketizing unit 140 may transmit the depacketized result as a second up signal U2 to the second encoding and decoding unit 130.

The second encoding and decoding unit 130 receives the second up signal U2 from the packetizing and depacketizing unit 140. For example, the second up signal U2 may include data and recovery data transmitted from an external image data communication device. The second encoding and decoding unit 130 may perform packet loss recovery decoding by using the data and recovery data. For example, the packet loss recovery decoding may be an operation for recovering missing packets while delivered on the public network 11. The second encoding and decoding unit 130 may recover missing data corresponding to missing packets without a retransmission request. The second encoding and decoding unit 130 transmits data and recovered data as the first up signal U1 to the first encoding and decoding unit 120.

The first encoding and decoding unit 120 receives the first up signal U1 from the second encoding and decoding unit 130. The first encoding and decoding unit 120 may decode the first up signal U1. For example, the first encoding and decoding unit 120 may decode the first up signal U1 on the basis of the standards such as H.264/AVC and HEVC. Once decoding is performed, image data is recovered. The first encoding and decoding unit 120 transmits the recovered image data to the input and output unit 110.

The input and output unit 110 may include a user output means such as a display device outputting images and a speaker outputting voices. The input and output unit 110 receives image data from the first encoding and decoding unit 120 and may play images by using the received image data.

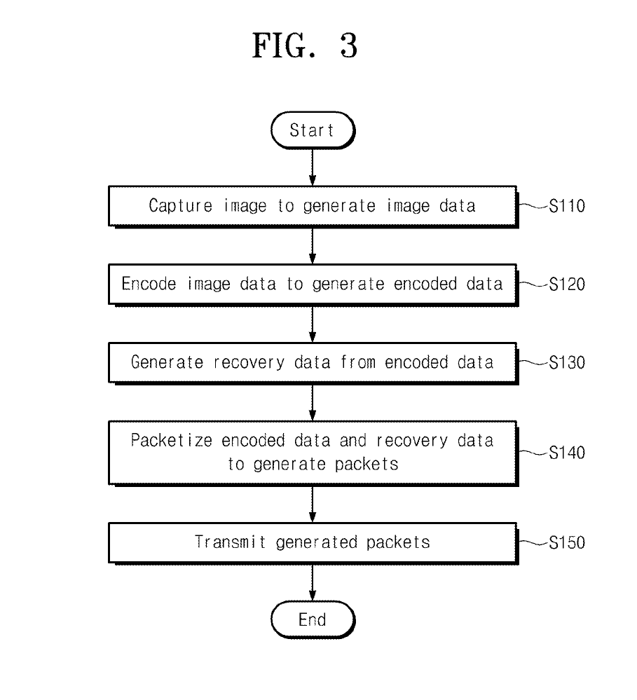

FIG. 3 is a flowchart illustrating a method of the image data communication device 100 to transmit image data according to an embodiment of the present invention. Referring to FIGS. 2 and 3, the image data communication device 100 captures images and generates image data in operation S110. For example, the input and output unit 110 captures images and then generates image data.

In operation S120, the image data communication device 100 encodes image data to generate encoded data. For example, the first encoding and decoding unit 120 encodes image data to generate encoded data.

In operation S130, the image data communication device 100 generates recovery data from the encoded data. For example, the second encoding and decoding unit 130 may generate recovery data from encoded data.

In operation S140, the image data communication device 100 packetizes the encoded data and the recovery data to generate packets. For example, the packetizing and depacketizing unit 140 may packetize the encoded data and the recovery data to generate packets.

In operation S150, the image data communication device 100 transmits the generated packets. For example, the transceiver 160 may transmit the generated packets.

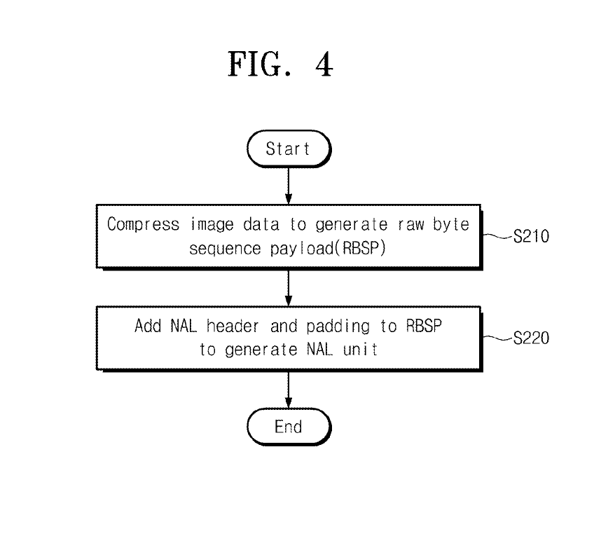

FIG. 4 is a flowchart illustrating a method of the image data communication device 100 to encode image data in operation S120 according to an embodiment of the present invention. Referring to FIGS. 2 and 4, the image data communication device 100 compresses image data to generate raw byte sequence payload (RB SP) data in operation S210.

In operation S220, the image data communication device 100 adds a network abstraction layer (NAL) header and a padding to the RBSP data to generate an NAL unit.

For example, the encoding method of FIG. 4 may be performed on each picture (or a frame) of an image processed by the image data communication device 100. That is, the image data communication device 100 may generate one NAL unit from one picture (or frame).

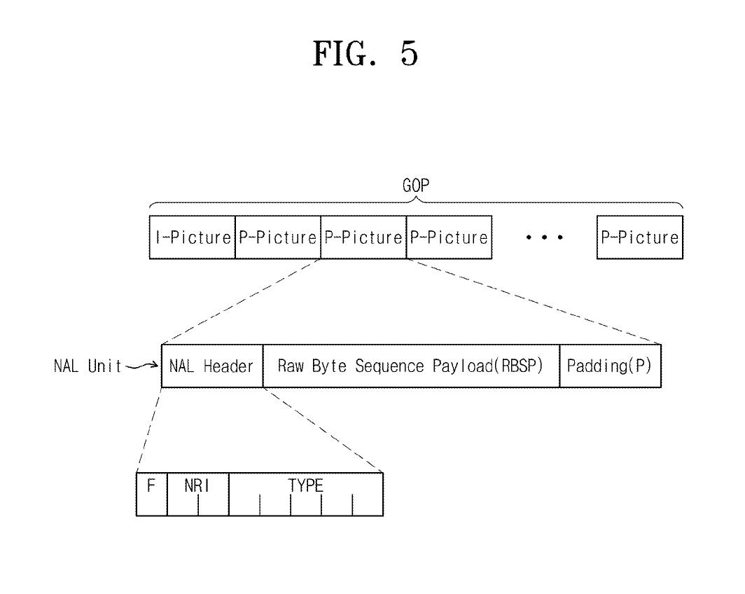

FIG. 5 is a view illustrating an NAL unit generated by the image data communication device 100. Referring to FIG. 5, the image data communication device 100 may manage (or process) images in a unit of group of pictures (GOP). The GOP may include a plurality of pictures (or frames). For example, the GOP may have a size of ‘30 pictures/1 sec’. The GOP may include one I-picture and a plurality of P-pictures. The I-picture may be a start picture of the GOP and the P-picture may be picture referring to an I-picture or a previous P-picture.

Each of the I-picture and P-pictures may have the same structure. Each picture may include an NAL header, an RBSP, and a padding P.

The NAL header may be configured with 8 bits or (one byte). The first bit of the NAL header may be a fixed bit F. The fixed bit F may indicate that there is an error or a grammatical error. For example, if there is an error or a grammatical error, the fixed bit F may be ‘1’. If there is no error or grammatical error, the fixed bit F may be ‘0’.

The second and third bits of the NAL header may be a reference indicator. When the NAL unit is not used for reference, the reference indicator may be ‘00’. When the NAL unit is used for reference, the reference indicator may be ‘01’, ‘10’, or ‘11’.

The remaining bits of the NAL header, as a type indicator, may indicate the type of a payload in the NAL unit. For example, a type of the NAL unit and a payload structure according to a value of the type indicator may be defined in Table 1.

TABLE 1

| Type indicator | Type | Payload structure |
|---|---|---|
| 0 | No | |
| 1-23 | NAL unit | One NAL unit forms one packet |
| 24 | STAP-A | A plurality of NAL units form one packet |
| 25 | STAP-B | A plurality of NAL units form one packet |
| 26 | MTAP16 | A plurality of NAL units form a plurality of |
| | | packets |
| 27 | MTAP24 | A plurality of NAL units form a plurality of |
| | | packets |
| 28 | FU-A | One NAL unit forms a plurality of packet |
| 29 | FU-B | One NAL unit forms a plurality of packet |
| 30-31 | No | |

For example, the type indicator of the NAL header may be determined depending on the size of a payload in the NAL unit and the maximum transfer unit (MTU) of the public network 11 (see FIG. 1). The MTU may be the maximum size of data transmitted by the public network 11, that is, data transmitted with one packet. The MTU may be determined depending on the type of a protocol used when the image data communication devices 12, 13, and 14 and the public network 11 communicate with each other.

When the video conferencing system 10 uses HD images, the size of the payload (i.e., one picture) in one NAL unit may be bytes of several thousands to tens of thousands. When the public network 11 uses internet protocol (IP), the MTU of the public network 11 may be less than 1500 bytes. That is, in a video conferencing system using HD images and IP, the size of the payload in the NAL unit may be several times to tens of times the MTU. Accordingly, in a video conferencing system using HD images and IP, the payload in the NAL unit may be set to FU-A or FU-B.

For example, the I-picture does not refer to a picture and the P-picture refers to an I-picture or a previous P-picture. Accordingly, the size of the payload in an I-picture may be several times to tens of times the size of the payload in a P-picture.

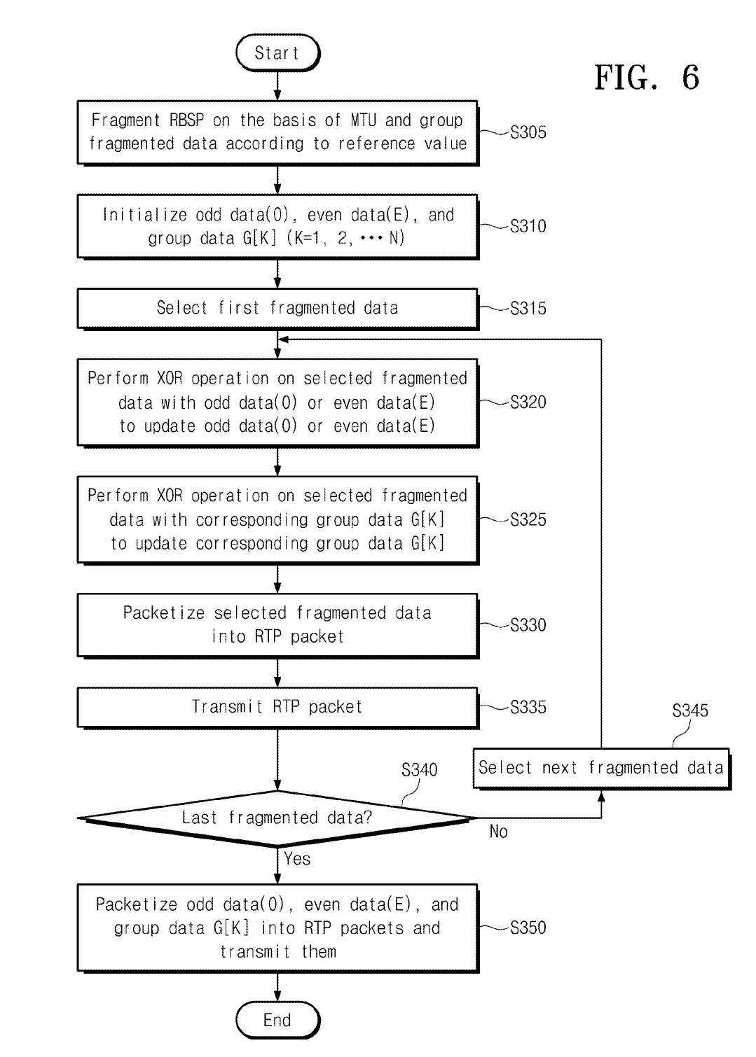

FIG. 6 is a flowchart illustrating a method of the image data communication device 100 to perform missing packet recovery decoding and packetizing on data and transmit it according to an embodiment of the present invention. For example, a method of the image data communication device 100 to perform missing packet recovery decoding and packetizing on one NAL unit and transmit the NAL unit is shown in FIG. 6.

Referring to FIGS. 2 and 6, the image data communication device 100 fragments an RBSP on the basis of an MTU and groups the fragmented data according to a reference value in operation S305. For example, the second encoding and decoding unit 130 may generate recovery data from encoded data. For example, data added to each fragmented data and an RBSP may be fragmented by the packetizing and depacketizing unit 140 to allow the entire size of each fragmented data to be equal or less than the MTU. For example, the MTU of the public network 11 (see FIG. 1) may be set to 1500 bytes and the size of each fragmented data may be set to less than 1400 bytes.

For example, the second encoding and decoding unit 130 may group a plurality of fragmented data according to a reference value. For example, when the reference value is I, the first fragmented data to Ith fragmented data among the plurality of fragmented data may be grouped as a first group. The I+1th fragmented data to 2Ith fragmented data may be grouped as a second group. In the same manner, each of the plurality of fragmented data may be grouped to have a corresponding group.

For example, the reference value may be a value preset in the second encoding and decoding unit 130. The reference value may be a value adjusted by a user of the image data communication device 100, according to the property (for example, resolution and the number of frames per second) of image data processed by the image data communication device 100, or according to a communication environment of the network 11.

In operation S310, the image data communication device 100 initializes odd data O, even data E, and group data G[K]. The odd data O, the even data E, and the group data G[K] data used when the second encoding and decoding unit 130 generates recovery data. The number N of the group data G[K] may be identical to the number of groups of a plurality of fragmented data. Each of the odd data O, the even data E, and the group data G[K] have the same size as each fragmented data. Each of the odd data O, the even data E, and the group data G[K] may be initialized with a bit stream configured with ‘0’. For example, operation S305 and operation S310 may be performed at the same time or in the reverse order.

In operation S315, the image data communication device 100 selects the first fragmented data from a plurality of fragmented data. For example, the second encoding and decoding unit 130 may select the first fragmented data from a plurality of fragmented data.

In operation S320, the image data communication device 100 performs an operation on the selected fragmented data with the even data E or the odd data O so as to update the even data E or the odd data O. For example, when the selected fragmented data is odd fragmented data such as the first fragmented data and the third fragmented data, the second encoding and decoding unit 130 may perform an XOR operation on the selected fragmented data and the odd data O. XOR operation is performed on each bit of the selected fragmented data and a bit corresponding to the ODD data O and each bit of the odd data O may be replaced with an operation result bit.

For example, when the selected fragmented data is even fragmented data such as the second fragmented data and the fourth fragmented data, the second encoding and decoding unit 130 may perform an XOR operation on the selected fragmented data and the even data E. XOR operation is performed on each bit of the selected fragmented data and a bit corresponding to the even data E and each bit of the even data O may be replaced with an operation result bit.

In operation S325, the image data communication device 100 performs an operation on the selected fragmented data with corresponding group data G[K] so as to update the corresponding group data G[K]. For example, when the selected fragmented data belongs to the first group (K=1), the second encoding and decoding unit 130 may perform XOR operation on the selected fragmented data and the first group data G[1]. XOR operation is performed on each bit of the selected fragmented data and a bit corresponding to the first group data G[1] and each bit of the first group data G[1] may be replaced with an operation result bit.

For example, when the selected fragmented data belongs to the second group (K=2), the second encoding and decoding unit 130 may perform XOR operation on the selected fragmented data and the second group data G[2]. XOR operation is performed on each bit of the selected fragmented data and a bit corresponding to the second group data G[2] and each bit of the second group data G[2] may be replaced with an operation result bit.

In operation S330, the image data communication device 100 packetizes the selected fragmented data as a real-time transport protocol (RTP). For example, the packetizing and depacketizing unit 140 may packetize the selected fragmented data as an RTP packet.

In operation S335, the image data communication device 100 transmits the RTP packet. For example, the transceiver 150 may transmit the RTP packet to the public network 11.

In operation S340, the image data communication device 100 determines whether the selected fragmented data is the last fragmented data of an NAL unit. If the selected fragmented data is not the last fragmented data, the image data communication device 100 selects the next fragmented data in operation S345. Then, the image data communication device 100 may perform operation S320 to operation S340 by using the next fragmented data. If the selected fragmented data is the last fragmented data, the image data communication device 100 performs operation S350.

In operation S350, the image data communication device 100 groups the odd data O, the even data E, and the group data G[K] as RTP packets. That is, once XOR operation on all fragmented data of an NAL unit is terminated, the odd data O, the even data E, and the group data G[K] may be used as recovery data.

As mentioned above, the image data communication device 100 divides data of one picture (or frame) into a plurality of fragmented data and generates recovery data by performing XOR operation on at least two fragmented data. Different recovery data may be generated from different ranges of fragmented data such as odd numbers, even numbers, and groups. The image data communication device 100 may transmit packets corresponding to recovery data after transmitting packets corresponding to fragmented data. That is, when one NAL unit is transmitted, the image data communication device 100 may additionally transmit a frame generated using XOR operation in addition to data of a picture (or frame).

An example of transmitting one NAL unit is described in detail with reference to the flowchart of FIG. 6. However, the technical idea of the present invention is not limited to the embodiment of FIG. 6. For example, the image data communication device 100 may generate the odd data O, the even data E, and the group data G[K] through operation S320, operation S325, and operation S345. Then, the image data communication device 100 packets the fragmented data, the odd data O, the even data E, and the group data G[K] as RTP packets and transmits them.

For example, the image data communication device 100 may generate the odd data O, the even data E, and the group data G[K] through operation S320 and operation S325 and may perform packetization and transmission through operation S330 and operation S335 at the same time.

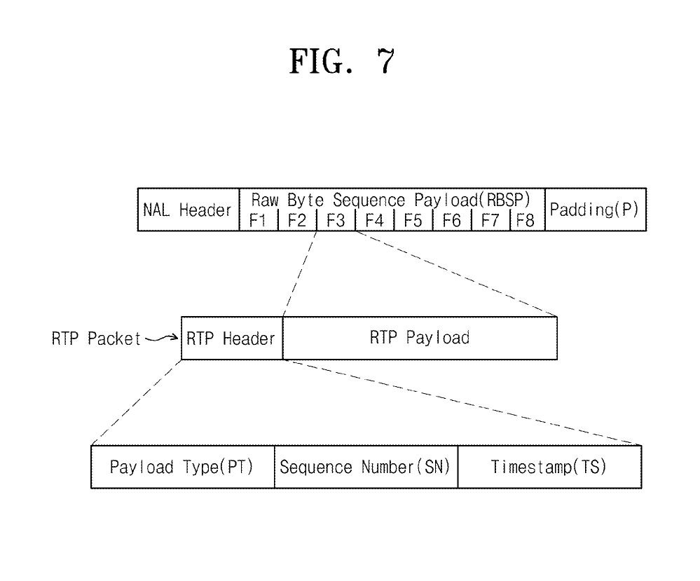

FIG. 7 is a view when each fragmented data of the RBSP in an NAL unit is packetized. An example in which the third fragmented data F3 among first to eighth fragmented data F1 to F8 of the RBSP is packetized as an RTP packet is shown in FIG. 7. However, the packetization described with reference to FIG. 7 may be identically applied to the first to eighth fragmented data F1 to F8.

Referring to FIGS. 2 and 7, the packetizing and depacketizing unit 140 generates an RTP packet by using each fragment of the RBSP. The RTP packet includes an RTP header and an RTP payload. Each fragmented data of the RBSP may be included in the RTP payload.

The RTP header includes information on a payload type PT, a sequence number SN, and a timestamp TS. The payload type PT may include seven bits. The payload type PT indicates various types of fragmented data in the RTP payload. For example, when fragmented data included in the RTP payload is data of HD images, the payload type PT may have a value of ‘121’. When fragmented data included in the RTP payload is data of QCIF images, the payload type PT may have a value of ‘120’.

The sequence number SN may include 16 bits. The sequence number SN may include information on the order of an RT packet. For example, the sequence number SN may indicate the order of an RTP packet in one NAL unit. As another example, the sequence number SN may indicate the order of an RTP packet in a plurality of NAL units.

The timestamp TS may include 32 bits. The timestamp TS includes information on a time at which fragmented data in the RTP payload is sampled. For example, the timestamp TS may include information on a time at which the first byte of fragmented data in the RTP payload is sampled. The time information of the timestamp TS may be determined according to a clock of 90 KHz.

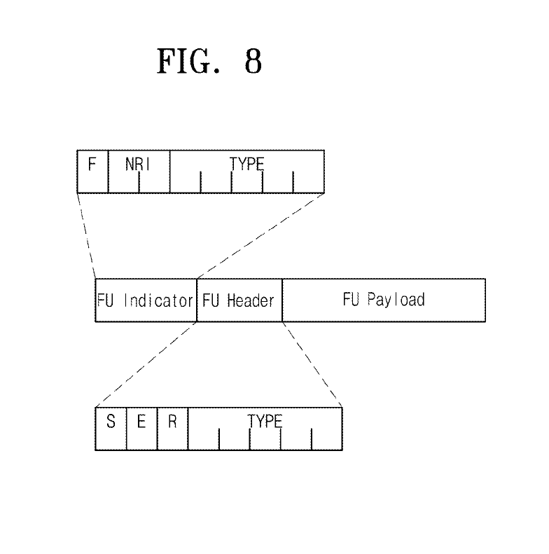

FIG. 8 is a view illustrating an RTP payload including fragmented data. For example, an RTP payload having a FU-A type structure is shown in FIG. 8. However, the technical idea of the present invention is not limited to the FU-A type.

Referring to FIG. 8, the FTP payload includes an FU indicator, an FU header, and an FU payload. Fragmented data may be included in the FU payload.

The FU indicator may include a fixed bit F, a reference indicator NRI, and a type indicator TYPE. The FU indicator may include the same information as the NAL header described with reference to FIG. 5.

The FU header includes a start bit S, an end bit E, a spare bit R, and a type indicator TYPR. The start bit S indicates whether the RTP payload includes the first fragmented data among fragmented data of an NAL unit. The end bit E indicates whether the RTP payload includes the last fragmented data among fragmented data of an NAL unit. The type indicator TYPE indicates whether an NAL unit corresponds to an I-picture or a P-picture. When the NAL unit corresponds to the I-picture, the type indicator TYPE may be set to ‘00101’. When the NAL unit corresponds to the P-picture, the type indicator TYPE may be set to ‘00001’.

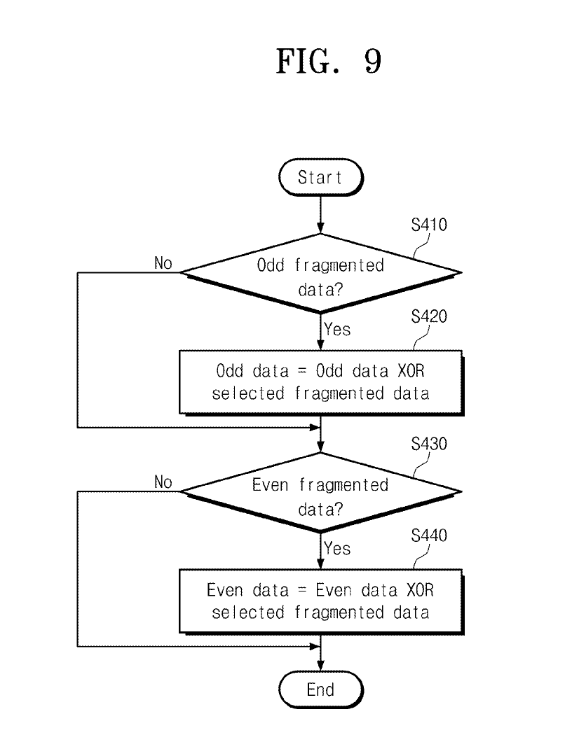

FIG. 9 is a flowchart illustrating operation S320 when the image data communication device 100 performs an operation on selected fragmented data with odd data O or even data E. Referring to FIG. 9, whether the selected fragmented data is odd fragmented data is determined in operation S410. When the selected fragmented data is the odd fragmented data, the odd data O is updated according to an operation result obtained from XOR operation on the odd data O and the selected fragmented data in operation S420.

In operation S430, whether the selected fragmented data is even fragmented data is determined. When the selected fragmented data is the even fragmented data, the even data E is updated according to an operation result obtained from XOR operation on the even data E and the selected fragmented data in operation S440.

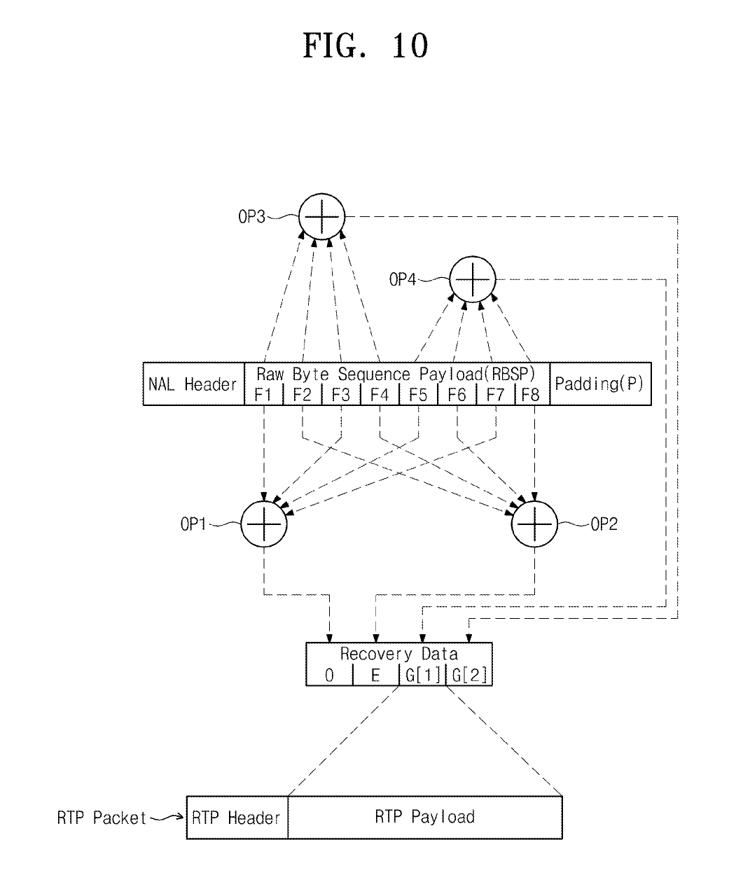

FIG. 10 is a view of generating recovery data. Referring to FIG. 10, it is assumed that the RBSP of an NAL unit is divided into first to eighth fragmented data F1 to F8. Among them, it is assumed that the first to fourth fragmented data F1 to F4 are grouped as a first group and the fifth to eighth fragmented data F5 to F8 are grouped as a second group.

A first operator OP1 indicates an algorithm for generating odd data O. The first operator OP1 may perform XOR operation on the first, third, fifth, and seventh fragmented data F1, F3, F5, and F7 among the first to eighth fragmented data F1 to F8. The odd data O calculated by the first operator OP1 may be used as recovery data.

A second operator OP2 indicates an algorithm for generating even data E. The second operator OP2 may perform XOR operation on the second, fourth, sixth, and eighth fragmented data F2, F4, F6, and F8 among the first to eighth fragmented data F2 to F8. The even data E calculated by the second operator OP2 may be used as recovery data.

A third operator OP3 indicates an algorithm for generating first group data G[1]. The third operator OP3 may perform XOR operation on the first to fourth data F1 to F4 belong to the first group among the first to eighth fragmented data F1 to F8. The first group data G[1] calculated by the third operator OP3 may be used as recovery data.

A fourth operator OP4 indicates an algorithm for generating second group data G[2]. The fourth operator OP4 may perform XOR operation on the fifth to eighth data F5 to F8 belong to the second group among the first to eighth fragmented data F1 to F8. The second group data G[2] calculated by the fourth operator OP4 may be used as recovery data.

Each of recovery data including the odd data O, the even data E, the first group data G[1], and the second group data G[2] may be packetized as an RTP packet. Each recovery data may be included in the RTP payload of an RTP packet.

As mentioned above, the recovery data is generated through XOR operation with fragmented data. Accordingly, the size of recovery data may be identical to the size of fragmented data.

Each recovery data may correspond to fragmented data in a predetermined range among a plurality of fragmented data of an NAL unit. Odd data O relates to odd fragmented data among the plurality of fragmented data of an NAL unit. Even data E relates to even fragmented data among the plurality of fragmented data of an NAL unit. The first group data G[1] relates to fragmented data in the first group among the plurality of fragmented data of an NAL unit. The second group data G[2] relates to fragmented data in the second group among the plurality of fragmented data of an NAL unit.

Ranges of recovery data may overlap each other but may not correspond to each other. For example, the first and third fragmented data F1 and F3 among fragmented data relating to the odd data O are included in the first group G[1]. The fifth and seventh fragmented data F5 and F7 among fragmented data relating to the odd data O are included in the second group G[2]. However, other recovery data corresponding to the odd data O do not exist.

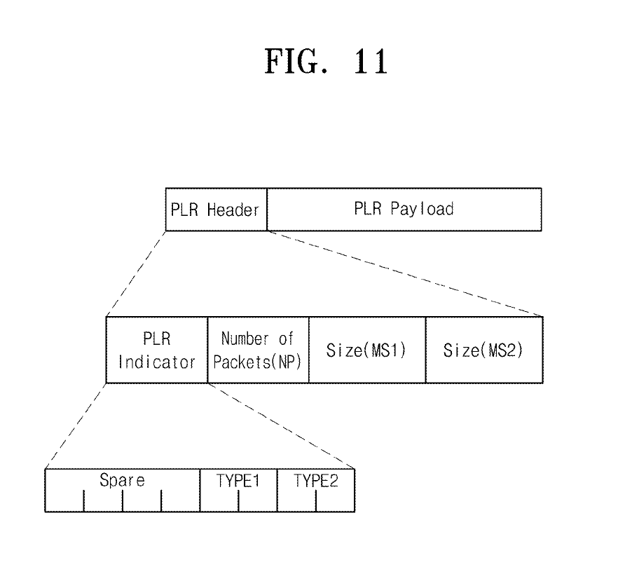

FIG. 11 is a view illustrating an RTP payload including recovery data. Referring to FIG. 11, the RTP payload includes a packet loss recovery (PLR) header and a PLR payload. The recovery data may be included in the PLR payload.

The PLR header may be configured with 4 bytes. The PLR header includes a PLR indicator, the number of packets NP, a first size MS1, and a second size MS2.

The PLR indicator may be configured with 1 byte. The PLR indicator includes spare bits, a first type indicator TYP1, and a second type indicator TYPE2. The spare bits may be 4 bytes. The first type indicator TYPE1 may include information on the type of a payload included in an NAL unit. For example, when the payload included in an NAL unit corresponds to an HD picture, the first type indicator TYPE1 may be set to ‘01’. For example, when the payload included in an NAL unit corresponds to an HD picture, the first type indicator TYPE1 may be set to ‘01’. The second type indicator TYPE2 may include information on the type of recovery data included in the PLR payload. When recovery data included in the PLR payload is odd data O, the second type indicator TYPE2 may be set to ‘00’. When recovery data included in the PLR payload is even data E, the second type indicator TYPE2 may be set to ‘01’. When recovery data included in the PLR payload is group data G[K], the second type indicator TYPE2 may be set to ‘10’.

The number of packets NP may have 1 byte. The number of packets NP indicates the number of fragmented data in an NAL unit. That is, when the image data communication device 100 transmits one NAL unit corresponding to one picture (or frame), the number of packets NP may indicate the number of RTP packets including image data instead of RTP packets including recovery data.

The first size MS1 may have 11 bits. The first size MS1 indicates the size of the last RTP packet among RTP packets generated from fragment data of one NAL unit. For example, the first size MS1 may indicate the size of an RTP packet where the end bit E of the FU header of FIG. 8 is set.

The second size MS2 indicates the number K of the group data G[K].

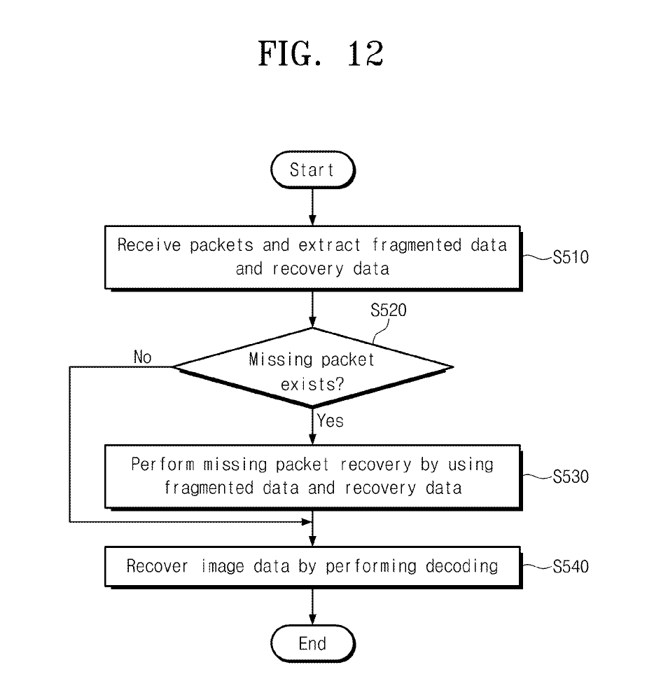

FIG. 12 is a flowchart when the image data communication device 100 receives and processes RTP packets according to an embodiment of the present invention. Referring to FIGS. 2 and 12, the image data communication device 100 receives RTP packets and extracts fragmented data and recovery data from the received RTP packets in operation S510. For example, the transceiver 150 may receive RTP packets and the packetizing and depacketizing unit 140 may extract fragmented data and recovery data from the RTP packets.

In operation S520, the image data communication device 100 determines whether there is a missing packet. For example, the packetizing and depacketizing unit 140 may determine whether there is a missing packet by referring to the sequence numbers SN (see FIG. 7) of RTP headers in RTP packets. For example, when the sequence numbers SN of received RTP packets are increased sequentially, it is determined that there is no missing packet. When the sequence numbers SN of received RTP packets are not increased sequentially and there is an empty sequence number N, it is determined that there is a missing packet. For example, an RTP packet corresponding to the empty sequence number SN may be determined as a missing packet.

If there is a missing packet, the image data communication device 100 may perform missing packet recovery by using fragmented data and recovery data in operation S530. For example, the second encoding and decoding unit 130 may attempt the recovery of fragmented data corresponding to the missing packet by using fragmented data and recovery data. If the recovery of fragmented data corresponding to a missing packet is successful or failed, the missing packet recovery is terminated.

If there is no missing packet or missing packet recovery is terminated, the image data communication device 100 performs decoding to recovery image data in operation S540. For example, the first encoding and decoding unit 120 decodes fragmented data to recovery image data.

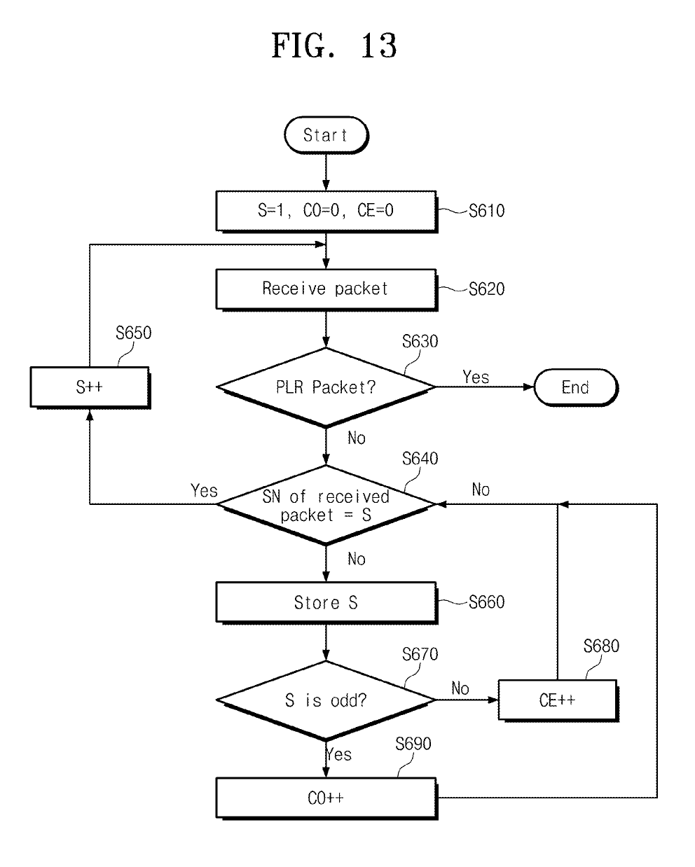

FIG. 13 is a flowchart illustrating a method of the image data communication device 100 to determine whether there is a missing packet in operation S520. For example, a method of determining whether there is a missing packet in RTP packets relating to odd data O or even data E is shown in FIG. 13.

Referring to FIGS. 2 and 13, a sequence variable S is initialized to ‘1’ in operation S610. An odd count CO and an even count CE are initialized to ‘0’.

The sequence variable S indicates the sequence number SN of an RTP packet that needs to be received by the image data communication device 100. In an initial state, the first RTP packet of an NAL unit has a sequence number SN of ‘1’. Accordingly, the sequence variable S is initialized to ‘1’ in an initial state. The sequence variable S is used to determine a missing packet. The sequence variable S and an algorithm relating to this may be applied as various algorithms having the same effect. The odd count CO indicates the number of missing packets occurring from RTP packets relating to the odd data O. The even count CE indicates the number of missing packets occurring from RTP packets relating to the even data E.

In operation S620, the packetizing and depacketizing unit 140 receives RTP packets. For example, the packetizing and depacketizing unit 140 may receive an RTP packet from the transceiver 150 or may select the oldest received RTP from the transceiver 150.

In operation S630, the packetizing and depacketizing unit 140 determines whether the received RTP packet is a PLR packet. For example, when the RTP payload of the received RTP packet includes a PLR header and a PLR payload, the received RTP packet may be determined as a PLR packet. When the received RTP packet is a PLR packet, RTP packets relating to fragmented data are all in a received state. Accordingly, the count of missing packets is terminated. When the received RTP packet is not a PLR packet, operation S640 is performed.

In operation S640, whether the sequence number SN (see FIG. 7) of the received RTP packet is identical to the sequence variable S is determined When the sequence number SN of the received RTP packet is identical to the sequence variable S, there is no missing packet between a previously received RTP packet and a currently received RTP packet. Therefore, the sequence variable S is increased by ‘1’ in operation S650 and operation S620 is performed again.

When the sequence number SN of the received RTP packet is not identical to the sequence variable S, there is a missing packet between a previously received RTP packet and a currently received RTP packet. If there is a missing packet, operation S660 is performed.

In operation S660, the packetizing and depacketizing packetizing and depacketizing unit 140 stores the sequence variable S corresponding to the missing packet.

In operation S670, whether the sequence variable S is an odd number is determined. If the sequence variable S is not an odd number, it is determined that an even packet is missing. Accordingly, the even count CE is increased by ‘1’ in operation S680. If the sequence variable S is an odd number, it is determined that an even packet is missing. Accordingly, the odd count CO is increased by ‘1’ in operation S690. After the odd count CO and the even count CE are increased, operation S640 is performed again.

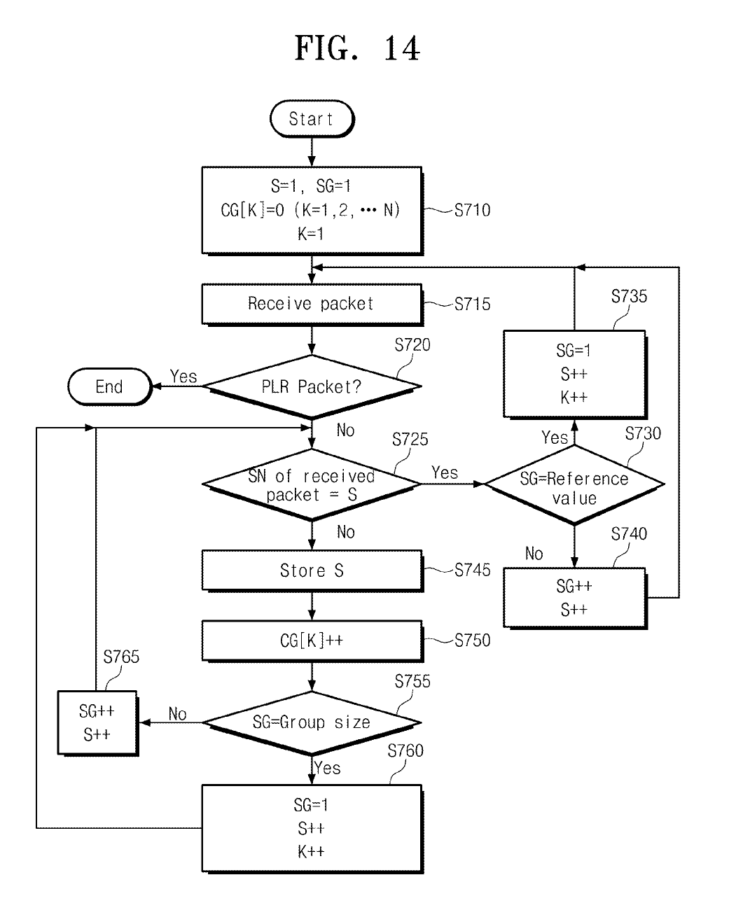

FIG. 14 is a flowchart illustrating a method of the image data communication device 100 to determine whether there is a missing packet in operation S520 according to another embodiment of the present invention. For example, a method of determining whether there is a missing packet in RTP packets relating to group data G[K] is shown in FIG. 14.

Referring to FIGS. 2 and 14, a sequence variable S and a group sequence variable SG are initialized to ‘1’ in operation S710. Group counts CG[K] are initialized to ‘0’. A group variable K is initialized to ‘1’.

The sequence variable S indicates the sequence number SN of an RTP packet that needs to be received by the image data communication device 100. In an initial state, the first RTP packet of an NAL unit has a sequence number SN of ‘1’. Accordingly, the sequence variable S is initialized to ‘1’ in an initial state. The sequence variable S is used to determine a missing packet. The sequence variable S and an algorithm relating to this may be applied as various algorithms having the same effect.

The group sequence variable SG indicates the order in the group of an RTP packet that needs to be received by the image data communication device 100. In an initial state, the first RTP packet of an NAL unit has a sequence number SN of ‘1’. Accordingly, the group sequence variable GS is initialized to ‘1’ in an initial state. The group sequence variable SG is used to determine to which group the received RTP packet belongs. The group sequence variable SG and an algorithm relating to this may be applied as various algorithms having the same effect.

The group counts CG[K] indicates the number of missing packets occurring from RTP packets relating to the group data G[K]. The group variable K indicates a group that RTP packets (or fragmented data) belong.

In operation S715, the packetizing and depacketizing unit 140 receives RTP packets. For example, the packetizing and depacketizing unit 140 may receive an RTP packet from the transceiver 150 or may select the oldest received RTP from the transceiver 150.

In operation S720, the packetizing and depacketizing unit 140 determines whether the received RTP packet is a PLR packet. For example, when the RTP payload of the received RTP packet includes a PLR header and a PLR payload, the received RTP packet may be determined as a PLR packet. When the received RTP packet is a PLR packet, RTP packets relating to fragmented data are all in a received state. Accordingly, the count of missing packets is terminated. When the received RTP packet is not a PLR packet, operation S725 is performed.

In operation S725, whether the sequence number SN (see FIG. 7) of the received RTP packet is identical to the sequence variable S is determined When the sequence number SN of the received RTP packet is identical to the sequence variable S, there is no missing packet between a previously received RTP packet and a currently received RTP packet. If there is no missing packet, operation S730 is performed. When the sequence number SN of the received RTP packet is not identical to the sequence variable S, there is a missing packet between a previously received RTP packet and a currently received RTP packet. If there is a missing packet, operation S745 is performed.

If there is no missing packet, it is determined whether the group sequence variable SG reaches a reference value indicating a group size in operation S730. If the group sequence variable SG reaches the reference value SG, the group sequence variable SG is initialized to ‘1’ and the sequence variable S is increased by ‘1’ and the group variable K is increased by ‘1’ in operation S735. Then, operation S715 is performed. That is, the check of a missing packet is performed in the next group. If the group sequence variable SG does not reach the reference value SG, the group sequence variable SG is increased by ‘1’ and the sequence variable S is increased by ‘1’ in operation S740. Then, operation S715 is performed. That is, the check of a missing packet is performed on the next RTP packet in the same group.

If there is a missing packet, the sequence variable S is stored in operation S745 and the group count CG[K] is increased by ‘1’ in operation S750. Then, operation S755 is performed.

In operation S755, it is determined whether the group sequence variable SG reaches the reference value indicating a group size. If the group sequence variable SG reaches the reference value, the group sequence variable SG is initialized to ‘1’ and the sequence variable S is increased by ‘1’ and the group variable K is increased by ‘1’ in operation S760. Then, operation S725 is performed. That is, the check of a missing packet is performed in the next group. If the group sequence variable SG does not reach the reference value SG, the group sequence variable SG is increased by ‘1’ and the sequence variable S is increased by ‘1’ in operation S765. Then, operation S725 is performed. That is, the check of a missing packet is performed on the next RTP packet in the same group.

For example, the missing packet check of FIG. 13 and the missing packet check of FIG. 14 may be performed in parallel. When the missing packet checks of FIGS. 13 and 14 are performed, an odd counter CO, an even count CE, and group counts CG[K], which indicate the number of missing packets, are calculated. Additionally, sequence variables S corresponding to missing packets are obtained. That is, the number of missing packets and the positions of missing packets respectively corresponding to recovery data generated at a transmission terminal are obtained.

For example, the methods of FIGS. 13 and 14 may be performed in parallel to a depacketization through the packetizing and depacketizing unit 140. The packetizing and depacketizing unit 140 may deliver depacketized fragmented data and recovery data, and sequence variables S corresponding to the odd count CO, the even count CE, the group counts CG[K], and the missing packets to the second encoding and decoding unit 130.

For another example, the packetizing and depacketizing unit 140 may perform a depacketizing operation. The packetizing and depacketizing unit 140 may deliver parameters necessary for missing packet check such as the sequence numbers SN together with fragmented data and recovery data to the second encoding and decoding unit 130. The second encoding and decoding unit 130 may check a missing packet, described with reference to FIGS. 13 and 14, by using fragmented data and parameters relating to fragmented data.

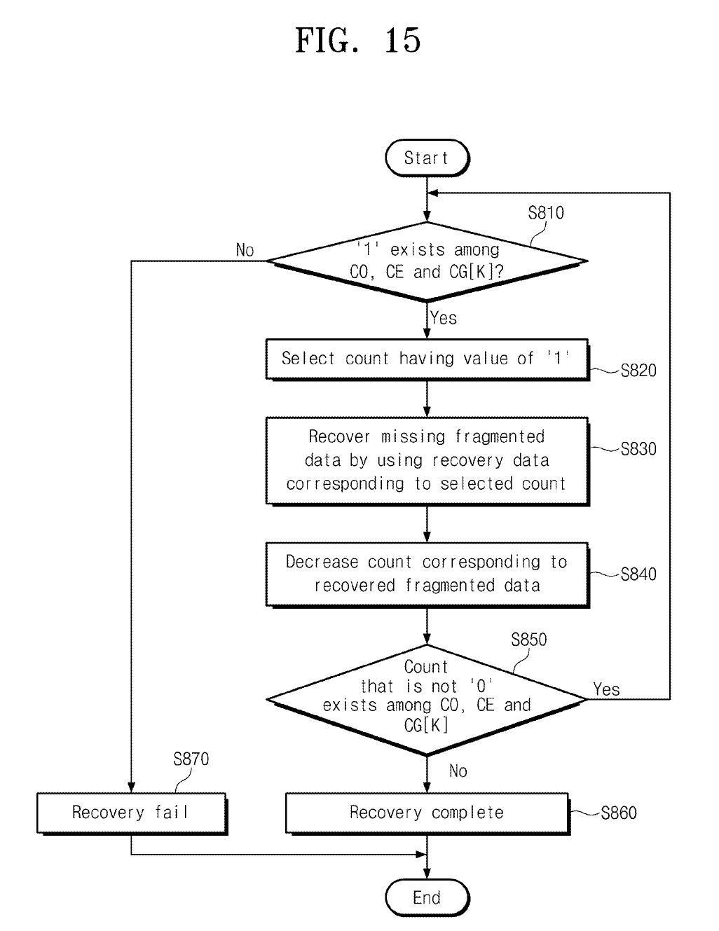

FIG. 15 is a flowchart illustrating a method of the image data communication device 100 to perform a missing packet recovery operation according to an embodiment of the present invention. For example, when a missing packet occurs, an example of recovering a missing packet is shown in FIG. 15. For example, the missing packet recovery of FIG. 15 may be performed by the second encoding and decoding unit 130 of FIG. 2.

Referring to FIG. 15, whether there is a count having a value of ‘1’ among an odd count CO, an even count CE, and group counts CG[K] is determined in operation S810. If there is no count having a value of ‘1’, it is determined that the missing packet recovery is failed in operation S870 and the missing packet recovery is terminated. If there is a count having a value of ‘1’, operation S820 is performed.

In operation S820, a count having a value of ‘1’ is selected.

In operation S830, missing fragmented data corresponding to a missing packet is recovered by using recovery data corresponding to the selected count. For example, an XOR operation may be performed on the selected recovery data and the received fragmented data corresponding to the selected recovery data. The XOR operation result may be missing fragmented data. The recovered fragmented data may be inserted into a position corresponding to a sequence variable S by using a pre-stored sequence variable S.

In operation S840, a count corresponding to the recovered fragmented data is reduced.

In operation S850, whether there is a count having a value of ‘0’ among the odd count CO, the even count CE, and the group counts CG[K] is determined in operation S850. That is, whether there is a missing packet that is not recovered yet is determined. If there is a missing packet that is not recovered yet, operation S810 is performed. If there is no missing packet that is not recovered yet, it is determined that the missing packet recovery is successful in operation S860 and the missing packet recovery is terminated.

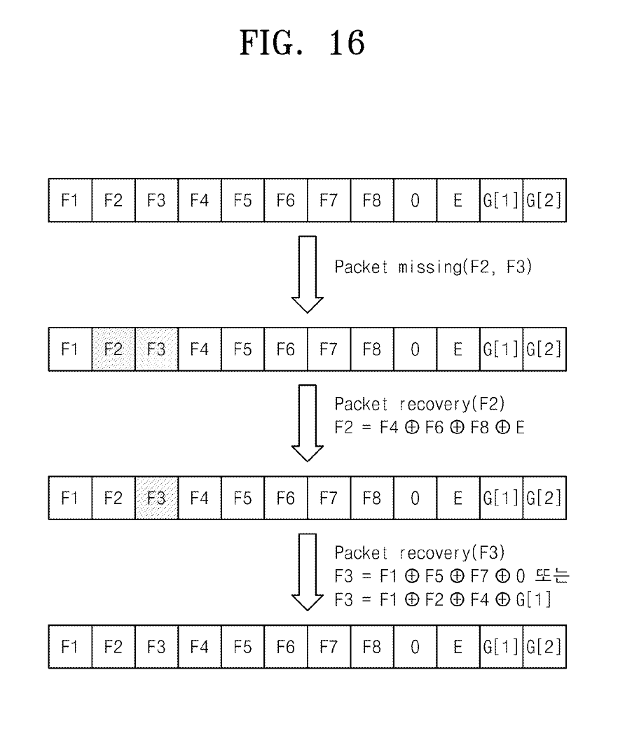

FIG. 16 is a view when a missing packet recovery is performed. Referring to FIGS. 1 and 6, the image data communication device 12 may be a transmitter transmitting image data and the image data communication device 13 may be a receiver receiving image data.

The image data communication device 12 may packetize first to eighth fragmented data F1 to F8 corresponding to one NAL unit into RTP packets and may then transmit them to the public network 11. The image data communication device 12 may packet recovery data including the odd data O, the even data E, and the group data G[1] and G[2], generated from the first to eighth fragmented data F1 to F8, into RTP packets and may than transmit them to the public network 11.

While the RTP packets are transmitted through the pubic network 11, RTP packets corresponding to the second and third fragmented data F2 and F3 may be missing. That is, the image data communication device 130 may receive RTP packets corresponding to the first and fourth to eighth fragmented data F1 and F4 to F8, the odd data O, the even data E, and the group data G[1] and G[2].

The image data communication device 13 may detect that RTP packets corresponding to the second and third fragmented data F2 and F3 are missing and may perform a missing packet recovery operation on the second and third fragmented data F2 and F3.

When the second and third fragmented data F2 and F3 are missing, the odd count CO is ‘1’, the even count CE is ‘1’, the first group count CG[1] is ‘2’, and the second group count CG[2] is ‘0’. The image data communication device 13 may perform a missing packet recovery operation by using the odd count CO or the even count CE, which has a value of ‘1’.

For example, it is assumed that the image data communication device 13 performs a missing packet recovery by using the even count CE. Even data E relating to the even count CE is a result obtained from an XOR operation on the second, fourth, sixth, and eighth fragmented data F2, F4, F6, and F8. Accordingly, the second fragmented data F2 may be calculated through an XOR operation on the fourth, sixth, and eighth fragmented data F4, F6, and F8.

When the second fragmented data F2 is recovered, the odd count CO and the first group count CG[1] are ‘1’ and the even count CE and the second group count CG[2] are ‘0’. The image data communication device 100 may perform a missing packet recovery operation by using the odd count CO or the first group count CG[1], which has a value of ‘1’.

Odd data O relating to the odd count CO is a result obtained from an XOR operation on the first, third, fifth, and seventh fragmented data F1, F3, F5, and F7. Accordingly, the third fragmented data F3 may be calculated through an XOR operation on the first, fifth, and seventh fragmented data F1, F5, and F7.

First group data G[1] relating to the first group count CG[1] is a result obtained from an XOR operation on the first to fourth fragmented data F1 to F4. Accordingly, the third fragmented data F3 may be calculated through an XOR operation on the first, second, and fourth fragmented data F1, F2, and F3 and the first group data G[1].

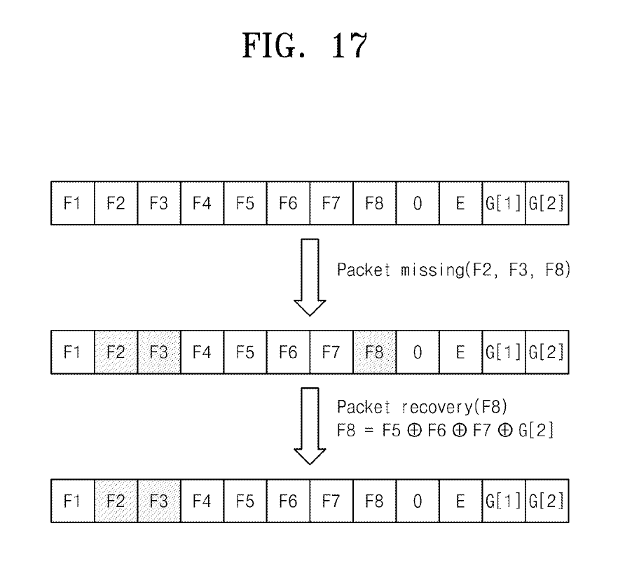

FIG. 17 is a view when a missing packet recovery is performed. Referring to FIGS. 1 and 17, the image data communication device 12 may be a transmitter transmitting image data and the image data communication device 13 may be a receiver receiving image data.

The image data communication device 12 may packetize first to eighth fragmented data F1 to F8 corresponding to one NAL unit into RTP packets and may then transmit them to the public network 11. The image data communication device 12 may packet recovery data including the odd data O, the even data E, and the group data G[1] and G[2], generated from the first to eighth fragmented data F1 to F8, into RTP packets and may than transmit them to the public network 11.

While the RTP packets are transmitted through the pubic network 11, RTP packets corresponding to the second, third, and eighth fragmented data F2, F3, and F8 may be missing. That is, the image data communication device 130 may receive RTP packets corresponding to the first and fourth to seventh fragmented data F1 and F4 to F7, the odd data O, the even data E, and the group data G[1] and G[2].

The image data communication device 13 may detect that RTP packets corresponding to the second, third, and eighth fragmented data F2, F3, and F8 are missing and may perform a missing packet recovery operation on the second, third, and eighth fragmented data F2, F3, and F8.

When the second, third, and eighth fragmented data F2, F3, and F8 are missing, the odd count CO is ‘1’, the even count CE is ‘2’, the first group count CG[1] is ‘2’, and the second group count CG[2] is ‘1’. The image data communication device 13 may perform a missing packet recovery operation by using the odd count CO or the even count CE, which has a value of ‘1’.

For example, it is assumed that the image data communication device 13 performs a missing packet recovery by using the second group count G[2]. Second group data G[2] relating to the second group count CG[2] is a result obtained from an XOR operation on the fifth to eighth fragmented data F5 to F8. Accordingly, the eighth fragmented data F8 may be calculated through an XOR operation on the fifth to seventh fragmented data F5 to F7 and the second group data G[2].

Then, in the same manner described with reference to FIG. 16, the second and third fragmented data F2 and F3 may be recovered.

According to the above-mentioned embodiments, it is described that the odd data O, the even data E, and the group data G[K] are used as recovery data. However, at least one of the odd data O, the even data E, and the group data G[K] may be used as recovery data.

According to the above-mentioned embodiments, it is described that the odd data O and the even data E are calculated from all fragmented data of one NAL unit. However, one NAL unit may be divided into a plurality of groups, and odd data O and even data E may be calculated for each group. Groups relating to the odd data O and the even data E may be identical to or different from groups relating to the group data G[K].

According to embodiments of the present invention, recovery packets are generated from image data packets at a transmission terminal of image data. At a reception terminal of image data, missing packets may be recovered by using image data packets and recovery packets. Accordingly, an image data communication method and device having improved reliability may be provided. Furthermore, since the retransmissions of missing packets are not required, an image data communication method and device having improved speed may be provided.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An image data communication method comprising:
generating encoding data by encoding image data;
generating recovery data by using the encoding data;
generating packets by packetizing the encoding data and the recovery data; and
transmitting the generated packets;
wherein the generating of the recovery data comprises:
dividing the encoding data into a plurality of fragmented data; and
generating the recovery data by performing an XOR operation on at least two fragmented data among the plurality of fragmented data.

2. The method of claim 1, wherein the generating of the recovery data comprises performing an XOR operation on odd fragmented data among the plurality of fragmented data.

3. The method of claim 1, wherein the generating of the recovery data comprises performing an XOR operation on even fragmented data among the plurality of fragmented data.

4. The method of claim 1, wherein the plurality of fragmented data are divided into a plurality of groups and the generating of the recovery data comprises performing an XOR operation on fragmented data in a group selected from the plurality of groups.

5. The method of claim 1, wherein the generating of the recovery data further comprises performing an XOR operation on at least two second fragmented data among the plurality of fragmented data to generate second recovery data, and
wherein during the generating of the packets, the second recovery data is packetized together with the encoding data and the recovery data.

6. The method of claim 5, wherein the at least two second fragmented data do not overlap with the at least two fragmented data.

7. The method of claim 5, wherein the at least two second fragmented data comprise fragmented data overlapping at least one fragmented data among the at least two fragmented data.

8. The method of claim 5, wherein during the generating of the packets, the second recovery data and the recovery data are packetized into different packets.

9. The method of claim 1, wherein the generating of the packets comprises:
packetizing the plurality of fragmented data into a plurality of first packets, respectively; and
packetizing the recovery data into a second packet.

10. The method of claim 9, wherein
the second packet comprises a real-time transport protocol (RTP) header and an RTP payload including the recovery data; and
the RTP header comprises information on a type of the RTP payload, a sequence number indicating an order of the RTP payload, and a timestamp indicating a time at which the RTP payload is sampled.

11. The method of claim 10, wherein
the RTP payload comprises a packet loss recovery (PLR) header and a PLR payload including the recovery data; and
the PLR header comprises information on a PLR indicator indicating the at least two fragmented data, a packet number indicating a number of the plurality of fragmented data, and a size of a last fragmented data among the plurality of fragmented data.

12. The method of claim 11, wherein when the recovery data is packetized into at least two packets, the PLR header further comprises information on a number of the at least two packets.

13. The method of claim 9, wherein
each of the first packets comprises an RTP header and an RTP payload including corresponding fragmented data among the plurality of fragmented data; and
the RTP header comprises information on a type of the RTP payload, a sequence number indicating an order of the RTP payload, and a timestamp indicating a time at which the RTP payload is sampled.

14. The method of claim 13, wherein the RTP payload comprises a fragmentation unit (FU) indicator, an FU header, and an FU payload including the corresponding fragmented data;
the FU indicator comprises information on a fixed bit indicating whether there is an error, a reference indicator indicating whether image data corresponding to the FU payload is used as a reference, and a type of the FU payload; and
the FU header comprises a start bit indicating a start of the plurality of fragmented data, an end bit indicating an end of the plurality of fragmented data, and a type of the FU payload.

15. An image data communication method comprising:
receiving a plurality of packets and at least one recovery packet;
determining whether a missing packet exists among the plurality of packets;
performing a missing packet recovery by using the plurality of packets and the at least one recovery packet when the missing packet exists, so as to recover the image data; and
performing decoding on the plurality of packets when the missing packet does not exist, so as to recover the image data,
wherein the missing packet recovery is performed by using an XOR operation on at least one packet among the plurality of packets and the recovery packet.

16. The method of claim 15, wherein the missing packet recovery comprises:
detecting first packets relating to the at least one recovery packet from the at least one recovery packet;
determining whether the missing packet is a recovery target on the basis of the missing packet and the first packets;
when the missing packet is the recovery target, recovering the missing packet on the basis of the at least one recovery packet and the first packets; and
when the missing packet is not the recovery target, terminating the missing packet recovery.

17. The method of claim 16, wherein the determining of whether the missing packet is the recovery target comprises, when the missing packet is one of the first packets, determining the missing packet as the recovery target.

18. The method of claim 17, wherein the recovering of the missing packet comprises performing an XOR operation on the remaining packets except for the missing packet among the first packets and the recovery packet, so as to recover the missing packet.

19. The method of claim 15, wherein the missing packet comprises first and second missing packets,
wherein the missing packet recovery comprises:
detecting first packets relating to a first recovery packet among the at least one recovery packet;
detecting second packets relating to a second recovery packet among the at least one recovery packet;
selecting a first priority recovery packet from the first recovery packet and the second recovery packet on the basis of the first and second missing packets, the first packets, and the second packets;
recovering one missing packet among the first and second missing packets by using the first priority recovery packet and packets relating to the first priority recovery packet; and
recovering the remaining one missing packet among the first and second missing packets by using a second priority recovery packet among the first recovery packet and the second recovery packet and packets relating to the second priority recovery packet.

20. An image data communication device comprising:
a first encoding unit configured to encode an image signal to output the encoded signal as a first down signal;
a second encoding unit configured to receive the first down signal, perform missing packet recovery encoding on the first down signal to output the encoded signal as a second down signal;
a packetizing unit configured to receive the second down signal, packetize the second down signal to output the packetized signal as a third down signal; and
a transceiver configured to receive the third down signal to transmit the received signal to an external device,
wherein the missing packet recovery encoding further comprises dividing the first down signal into a plurality of first fragmented data, performing an XOR operation on at least two fragmented data among the plurality of first fragmented data to generate first recovery data, and outputting the plurality of first fragmented data and the first recovery data as the second down signal.
